(19) United States
(12) Patent Application Publication
(10) Pub. No.: US 2011/0262854 A1
(43) Pub. Date: Oct. 27, 2011

(54) ELECTROPHOTOGRAPHIC TONER

(75) Inventor: Masahiro Ikuta, Shizuoka-ken (JP)

(73) Assignee: TOSHIBA TEC KABUSHIKI KAISHA, Tokyo (JP)

(21) Appl. No.: 13/084,613

(22) Filed: Apr. 12, 2011

Related U.S. Application Data
(60) Provisional application No. 61/327,876, filed on Apr. 26, 2010.

(51) Int. Cl. G03G 9/08

(52) U.S. Cl. 430/108.6; 430/110.1

(57) ABSTRACT

Disclosed is a toner having a controlled micro/semimacro roughness ratio, such that the toner surface has a ratio of {an average of an arithmetic average height (Ra) in a 0.5 μm-square region} to {an average of an arithmetic average height (Ra) in a 1 μm-square region} of 0.5 or more. As a result, the toner is provided with improved electrophotographic performances, including low environmental variation, less toner scattering, and improved image quality.

### CROSS-REFERENCE TO RELATED APPLICATION

This application is based upon and claims the benefit of priority from: U.S. provisional application 61/327,876, filed on Apr. 26, 2010, the entire contents of which are incorporated herein by reference.

### FIELD

Embodiments described herein relate generally to an electrophotographic toner, particularly to a toner having improved image forming performances by controlling surface roughnesses.

### BACKGROUND

In an electrophotographic process, an electric latent image is formed on an image carrier, the latent image is developed with a toner, and the toner image is transferred onto a transfer material such as paper and then fixed thereon by heating, pressing, and the like. As for the toner to be used, in order to form a full color image, not only a conventional toner of a single color of black, but also toners of a plurality of colors are used to form an image.

As the toner, a two-component developer to be used by mixing with carrier particles and a one-component developer to be used as a magnetic toner or a non-magnetic toner are known. These toners are produced by a dry process or a wet process. A kneading-and-pulverization method, which is a dry process, is a method for producing desired toner particles by melt-kneading a binder resin, a pigment, a release agent such as a wax, a charge control agent, and the like, cooling the resulting mixture, followed by finely pulverizing the cooled mixture, and then classifying the finely pulverized mixture. Inorganic and/or organic fine particles are added for attaching to the surfaces of toner particles produced by the kneading-and-pulverization method in accordance with the intended use, and thus, the toner can be obtained.

When toner particles are produced by the kneading-and-pulverization method, their shape is indefinite and their surface composition is not uniform in general. Although the shape and surface composition of toner particles are subtly changed depending on the pulverizability of the material to be used and conditions for the pulverization step, it is difficult to intentionally control the shape.

Further, as the wet process, there is employed a method for obtaining toner particles by preparing a resin dispersion liquid through emulsion polymerization, and also separately preparing a coloring agent dispersion liquid in which a coloring agent is dispersed in a solvent, mixing these dispersion liquids to form aggregated particles with a size corresponding to a toner particle diameter, and fusing the aggregated particles by heating. The emulsion polymerization aggregation method, includes: an emulsion polymerization aggregation method in which the toner shape can be arbitrarily controlled from an indefinite to a spherical shape by the selection of a heating temperature condition (JP-A-63-282752 and JP-A-6-250439), a phase-inversion emulsification method in which a pigment dispersion liquid or the like is added to a solution obtained by dissolving a resin in an organic solvent, and water is added thereto, and a mechanical shearing aggregation method in which fine particles are prepared by mechanical shearing in an aqueous medium without using an organic solvent, followed by aggregation and fusion (JP-A-9-311502).

In JP-A-2005-25803, variations in the amount of an external additive attached to the surface of a toner and the attached state of the external additive are suppressed by controlling the arithmetic average height (Ra) of the toner, and the transfer efficiency is intended to be improved by uniform electrification of the toner and a spacer effect of the external additive. Further, JP-A-2006-15464 aims at suppressing contamination inside the electrophotographic machine due to toner scattering by combining a toner having a uniform arithmetic average height (Ra) and a uniform distribution thereof with a carrier.

However, it was found that only by controlling the arithmetic average height (Ra) on the surface of a toner, a variation in charge amount due to a change in environmental conditions cannot be suppressed, and toner scattering and a variation in image forming performance such as image quality cannot be suppressed.

### DETAILED DESCRIPTION

In the invention, by controlling various dimensions of the surface roughness of a toner, a variation in charge amount between a low-temperature and low-humidity environment and a high-temperature and high-humidity environment is controlled, whereby it becomes possible to stably form an image under wide environmental conditions. More specifically, a decrease in image density due to an increase in charge amount can be suppressed under a low-temperature and low-humidity environment, and the deterioration of image quality such as fogging and toner scattering due to a decrease in charge amount can be suppressed under a high-temperature and high-humidity environment.

As a result of the study by the present inventors, it has been found that the surface roughness of a toner is divided into microscopic surface roughness in a small region and semi-macroscopic surface roughness including surface undulation in a larger region, and by controlling these to be uniform, an environmental variation can be suppressed. The invention is based on the above finding.

Hereinafter, embodiments of the invention will be described. In the following description, “part (s)” and “%” representing the composition are expressed by weight unless otherwise stated.

According to one embodiment of the invention, there is provided an electrophotographic toner containing at least a binder resin and a coloring agent, and optionally a release agent, wherein a toner surface has a ratio of {an average of an arithmetic average height (Ra) in a 0.5 μm-square region} to {an average of an arithmetic average height (Ra) in a 1 μm-square region} of 0.5 or more. Here, the term “arithmetic average height (Ra) in a 0.5 μm-square region” of a toner surface represents a microscopic surface roughness in a small region, and the term “arithmetic average height (Ra) in a 1 μm-square region” represents a semi-macroscopic surface roughness including surface undulation in a larger region. That is, when the ratio between these parameters (hereinafter referred to as “micro/semimacro roughness ratio”) is 0.5 or more and close to 1, a toner exhibiting a suppressed variation in performances under wide environmental can be realized.

If the micro/semimacro roughness ratio is less than 0.5, a variation in charge amount between a low-temperature and low-humidity environment and a high-temperature and high-humidity environment becomes significant. More specifically, a charge amount under a low-temperature and low-humidity environment is increased to result in a low image density. In addition, a charge amount under a high-temperature and high-humidity environment is decreased to result in an inferior image quality due to fogging and soiling inside the electrophotographic machine due to scattered toner.

The arithmetic average height (Ra) of a toner (particle) surface is a value obtained by sampling a standard length in the average line direction from a roughness curve, summing up the absolute values of deviations from the average line of the sampled length to the measured curve, to obtain an average of the deviations. A larger Ra represents a rougher surface state, and a smaller Ra represents a smoother state.

As a method for producing a toner according to the invention, a dry process employing a kneading-and-pulverization method, or a wet process such as an emulsion polymerization method, a phase-inversion emulsification aggregation method, or a mechanical shearing aggregation method can be used. A method for producing a toner by aggregation and fusion in which colored fine particles obtained by emulsion polymerization are aggregated and fused is particularly preferred because it allows the control of the toner surface state during the fusion step.

### (Starting Materials for Toner)

As starting materials for producing the toner according to the invention, any known materials such as a resin, a coloring agent, a color-forming compound, a color-developing agent, a release agent, a charge control agent, an aggregating agent, and a neutralizing agent, can be used.

### [Resin]

Examples of the binder resin to be used in the invention include styrene resins such as polystyrene, styrene/butadiene copolymers, and styrene/acrylic copolymers; ethylene resins, such as polyethylene, polyethylene/vinyl acetate copolymers, polyethylene/norbornene copolymers, and polyethylene/vinyl alcohol copolymers; polyester resins, acrylic resins, phenolic resins, epoxy resins, allyl phthalate resins, polyamide resins, and maleic acid resins. These resins may be used alone or in combination of two or more species thereof. When an encapsulated toner is formed, such a resin can also be used as a constituent resin of core particles or shell particles, or as a matrix resin in which encapsulated colored fine particles are dispersed. A polyester resins having an acid value of 1 or more may be a particularly preferred binder resin.

### [Coloring Agent]

As the coloring agent to be used in the invention, those conventionally used for producing a toner, inclusive of: carbon black, and organic or inorganic yellow, cyan, or magenta pigments or dyes, can be used alone or in admixture. In order to form an erasable toner, a coloring-decoloring system in which a color-forming compound, a color-developing agent, and a decoloring agent are combined may preferably be used. The colored fine particles constituting this coloring-decoloring system can also be dispersed in the binder resin after encapsulation thereof.

### [Color-Forming Compound]

The color-forming compound is representatively a leuco dye, and examples thereof include compounds having a lactone ring in each molecule, such as triphenylmethane compounds, diphenylmethane compounds, spiropyran compounds, fluoran compounds, and rhodamine lactam compounds. These can be used alone or in admixture of two or more species thereof.

### [Color-Developing Agent]

The color-developing agent that allows the color-forming compound to develop a color is a compound having a phenolic hydroxy group in each molecule, such as a hydroxyacetophenone compound, a hydroxy-benzophenone compound, a gallic acid ester compound, a benzenetriol compound, a bisphenol compound, a triphenol compound, or a cresol compound; or a compound having a phosphate group in each molecule such as phosphoric acid, a phosphoric acid monoester, or a phosphoric acid diester. These can be used alone or in admixture of two or more species thereof.

[Decoloring Agent]

As the decoloring agent, a known compound can be used as long as it can inhibit the color forming reaction between a leuco dye and a color-developing agent by heat so as to change the developed color to colorlessness in a three-component system containing a leuco dye (a color-forming compound), a color-developing agent, and a decoloring agent.

As the decoloring agent, particularly, a decoloring agent capable of forming a coloring-decoloring system utilizing the thermal hysteresis of a known decoloring agent disclosed in JP-A-60-264285, JP-A-2005-1369, or JP-A-2008-280523 has an excellent instantaneous erasing property. When a mixture of such a three-component system in a colored state is heated to a specific decoloring temperature (Th) or higher, the mixture can be de-colored. Further, even if the de-colored mixture is cooled to a temperature not higher than Th, the de-colored state is maintained. When the temperature of the mixture is further decreased, a coloring reaction between the leuco dye and the color-developing agent is caused again at a specific color restoring temperature Tc or below to restore the colored state, and therefore, it is possible to cause a reversible coloring and decoloring reaction. In particular, it is preferred that the decoloring agent to be used in the invention satisfies the following relationship: Th>Tr>Tc, wherein Tr represents room temperature. Examples of the decoloring agent capable of causing this thermal hysteresis include alcohols, esters, ketones, ethers, and acid amides. Of these, esters are particularly preferred.

Also, an encapsulating agent (shell material) for forming an outer shell of the coloring agent is not particularly limited and can be appropriately selected by those skilled in the art.

Examples of methods for encapsulating the coloring agent include an interfacial polymerization method, a coacervation method, an in-situ polymerization method, a drying-in-liquid method, and a curing-and-coating-in-liquid method. In particular, an in-situ method in which a melamine resin is used as a shell component, an interfacial polymerization method in which a urethane resin is used as a shell component, or the like, is preferred.

The coloring agent encapsulated as needed preferably has a cumulative 50% volume diameter (hereinafter simply referred to as “D50”) of from 0.5 to 3.5 μm. If D50 is outside the range of from 0.5 to 3.5 μm, encapsulation of the coloring agent can be obstructed so that the amount of released fine powder is increased.

Further, although it depends on the specific types of color-forming compound and color-developing agent, for example, by placing the encapsulated coloring agent at −20 to −30° C., the they are coupled to each other to form a color.

### [Release Agent]

As the release agent, a conventionally used release agent such as an aliphatic hydrocarbon wax, an oxide of an aliphatic hydrocarbon wax or a block copolymer thereof, a vegetable wax, an animal wax, a mineral wax, or a wax containing, as a main component, a fatty acid ester, may be used for adjusting a fixing temperature or a release property, or other purpose.

### [Charge Control Agent (CCA)]

In order to control the triboelectric chargeability of the toner, a charge control agent such as a metal-containing azo compound or a metal-containing salicylic acid derivative compound, may also be added as needed.

### [Surfactant]

Examples of surfactants which are used for dispersing colored fine particles prior to aggregation when the toner is produced by an aggregation method include anionic surfactants, such as sulfate-based, sulfonate-based, phosphate-based, and soap-based anionic surfactants; cationic surfactants, such as amine salt-based and quaternary ammonium salt-based cationic surfactants; and nonionic surfactants, such as polyethylene glycol-based, alkyl phenol ethylene oxide adduct-based, and polyhydric alcohol-based nonionic surfactants. Further, as surfactants for stabilizing fusion of particles after the aggregation, alkaline (earth) metal polycarboxylates are preferably used, while the above-mentioned surfactants can also be used.

### [Aggregating Agent]

Examples of the aggregating agent which can be used in the aggregation step of the invention include metal salts such as sodium chloride, calcium chloride, calcium nitrate, barium chloride, magnesium chloride, zinc chloride, magnesium sulfate, aluminum chloride, aluminum sulfate, and potassium aluminum sulfate; inorganic metal salt polymers such as polyaluminum chloride, polyaluminum hydroxide, and calcium polysulfide; polymeric aggregating agents such as polymethacrylic esters, polyacrylic esters, polyacrylamides, and acrylamide sodium acrylate copolymers; coagulating agents such as polyamines, polydiallyl ammonium halides, melanin formaldehyde condensates, and dicyandiamide; alcohols, such as methanol, ethanol, 1-propanol, 2-propanol, 2-methyl-2-propanol, 2-methoxyethanol, 2-ethoxy-ethanol, and 2-butoxyethanol; organic solvents, such as acetonitrile and 1,4-dioxane; inorganic acids, such as hydrochloric acid and nitric acid; and organic acids, such as formic acid and acetic acid.

### [Neutralizing Agent]

For the purpose of increasing the dispersion stability of polyester fine particles prior to the aggregation in the case of using polyester resin as the binder or controlling the dispersion stability of aggregated particles during the fusion, it is possible to use an inorganic base, such as sodium hydroxide or potassium hydroxide; an amine compound, such as dimethylamine or trimethylamine; alkaline (earth) metal polycarboxylates; or the like, as the neutralizing agent as needed.

### [Mechanical Shearing Device]

Examples of a pulverizing device in a kneading-and-pulverization method or a mechanical shearing device for producing (colored) fine particles to be aggregated include medium-free stirrers, such as ULTRA TURRAX (manufactured by IKA Japan K.K.), T.K. AUTO HOMO MIXER (manufactured by PRIMIX Corporation), T.K. PIPELINE HOMO MIXER (manufactured by PRIMIX Corporation), T.K. FILMICS (manufactured by PRIMIX Corporation), CLEAR MIX (manufactured by M Technique Co., Ltd.), CLEAR SS5 (manufactured by M Technique Co., Ltd.), CAVITRON (manufactured by EUROTEC, Co., Ltd.), and FINE FLOW MILL (manufactured by Pacific Machinery & Engineering Co., Ltd.); medium stirrers such as VISCO MILL (manufactured by Aimex Co., Ltd.), APEX MILL (manufactured by Kotobuki Industries Co., Ltd.), STAR MILL (manufactured by Ashizawa Finetech Co., Ltd.), DCP SUPER FLOW (manufactured by Nippon Eirich Co., Ltd.), MP MILL (manufactured by Inoue Manufacturing Co., Ltd.), SPIKE MILL (manufactured by Inoue Manufacturing Co., Ltd.), MIGHTY MILL (manufactured by Inoue Manufacturing Co., Ltd.), and SC MILL (manufactured by Mitsui Mining Co., Ltd.); and high-pressure impact-type dispersing devices such as ALTIMIZER (manufactured by Sugino Machine Limited), NANOMIZER (manufactured by Yoshida Kikai Co. Ltd.), and NANO 3000 (manufactured by Beryu Co., Ltd.).

### [Fusion]

In order to adjust the surface roughness state of toner particles formed from aggregated colored fine particles, the temperature of an aqueous dispersion liquid containing the aggregated particles is preferably raised to the glass transition temperature (Tg) or higher, more preferably to a range of Tg+10° C. to Tg+25° C., to control the fusion of the aggregated particles.

The particles after aggregation and fusion are washed with water and then dried, whereby toner particles having a micro/semimacro roughness ratio of 0.5 or more, preferably 0.65 or more and generally 0.9 or less and also having a volume-average particle diameter of from 3 to 8 μm, preferably from 3.5 to 7 μm, may be obtained.

### [External Additive]

To the thus obtained toner particles, an external additive, such as silica or titanium oxide having a particle diameter of from about 10 to 120 nm is added in an amount of from 0.3 to 4 parts based on 100 parts of the toner particles so as to attach to the surfaces of the toner particles, whereby a toner having a volume-average diameter of from 3 to 8 μm based on a particle size distribution determined by the Coulter method (measurement lower limit diameter of 2 μm when a 100 μm aperture is used), may be obtained.

### EXAMPLES

Hereinafter, the invention will be described more specifically with reference to Examples and Comparative Examples. The values of various properties described in the specification including the following examples are based on values measured according to the following methods.

### (Micro/Semimacro Roughness Ratio)

At least 100 toner particles (common to both cases where a sample toner contains an external additive and where a sample toner does not contain an external additive) were placed. While observing the toner particles from thereabove at a magnification of 3000 times using a color 3D laser microscope (“VK-9700” manufactured by Keyence Corporation), a 0.5 μm-square region and a 1 μm-square region around a top portion of each toner particle were scanned in the X-Y direction at a pitch of 0.01 μm, and an arithmetic average height in accordance with JIS B0601 was determined. This procedure was repeated for 100 toner particles, and an average of the Ra value for the 100 particles was obtained for each of the 0.5 μm-square region and the 1 μm-square region, and a ratio of {an average of an arithmetic average height (Ra) in a 0.5 μm-square region} to {an average of an arithmetic average height (Ra) in a 1 μm-square region} was determined as a micro/semimacro roughness ratio.

### (Particle Size Distribution of Toner)

The particle size distribution of a sample toner was measured using a particle size distribution measuring instrument manufactured by Beckman Coulter, Inc. (“Multisizer 3”, using a 100 μm aperture (measured particle size range: 2.0 to 60 μm)), and a volume-average diameter Dv and a coefficient of variation CV (%) (=standard deviation/Dv×100) were determined.

### (Specific Surface Area of Toner)

The BET specific surface area of a sample toner was measured using an automatic specific surface area/pore analyzer (TRISTAR 3000, manufactured by Shimadzu Corporation).

### (Diameter of (Colored) Fine Particle in Dispersion Liquid)

The diameter distribution of (colored) fine particles in a dispersion liquid was measured using a laser particle size analyzer (“SALD-7000” manufactured by Shimadzu Corporation, measured particle size range: 10 nm to 300 μm), and a volume-average diameter was determined.

### [Preparation of Dispersion Liquid of Resin-Pigment-Release Agent Mixture Fine Particles]

90 parts of a polyester resin (Tg=63.5° C., Tm=106° C., Acid value=10.5) as a binder resin, 5 parts of a copper phthalocyanine pigment as a coloring agent, and 5 parts of an ester wax as a release agent were mixed, and the resulting mixture was melt-kneaded using a twin-screw kneader which was set to a temperature of 120° C., whereby a kneaded material was obtained. The thus obtained kneaded material was coarsely pulverized to a volume-average particle diameter of 1.2 mm using a hammer mill manufactured by Nara Machinery Co., Ltd., whereby coarsely pulverized particles were obtained. The thus obtained coarsely pulverized particles were moderately pulverized to a volume-average particle diameter of 0.05 mm using a bantam mill manufactured by Hosokawa Micron Corporation, whereby moderately pulverized particles were obtained. 40 parts of the thus obtained moderately pulverized particles, 4 parts of sodium alkyl benzene sulfonate as an anionic surfactant, 1 part of triethylamine as an amine compound, and 55 parts of de-ionized water were processed at 160 MPa and 180° C. using a high-pressure impact-type dispersion device (NANO 3000, manufactured by Beryu Co., Ltd.), whereby a dispersion liquid of resin-pigment-release agent mixture fine particles having a volume-average particle diameter of 450 nm, was prepared.

### [Preparation of Dispersion Liquid of Resin-Release Agent Mixture Fine Particles]

95 parts of the same polyester resin (Tg=63.5° C., Tm=106° C., Acid value=10.5) as a binder resin, and 5 parts of the same ester wax as a release agent, respectively as used in the above preparation example, were mixed, and the resulting mixture was melt-kneaded using a twin-screw kneader which was set to a temperature of 120° C., whereby a kneaded material was obtained. The thus obtained kneaded material was coarsely pulverized to a volume-average particle diameter of 1.2 mm using a hammer mill manufactured by Nara Machinery Co., Ltd., whereby coarsely pulverized particles were obtained. The thus obtained coarsely pulverized particles were moderately pulverized to a volume-average particle diameter of 0.05 mm using a bantam mill manufactured by Hosokawa Micron Corporation, whereby moderately pulverized particles were obtained. 30 parts of the thus obtained moderately pulverized particles, 1.2 parts of sodium alkyl benzene sulfonate as an anionic surfactant, 1 part of triethylamine as an amine compound, and 67.8 parts of de-ionized water were processed at 160 MPa and 180° C. using a high-pressure impact-type dispersion device (NANO 3000, manufactured by Beryu Co., Ltd.), whereby a dispersion liquid of resin-pigment-release agent mixture fine particles having a volume-average particle diameter of 500 nm, was prepared.

### <Preparation of Dispersion Liquid of Coloring Agent>

Components including 1 part of 3-(2-ethoxy-4-diethylaminophenyl)-3-(1-ethyl-2-methylindol-3-yl)-4-azaphthalide (leuco dye), 5 parts of 2,2-bis(4-hydroxyphenyl)hexafluoropropane(color-developing agent), and 50 parts of a diester compound of pimelic acid and 2-(4-benzyloxyphenyl)ethanol (decoloring agent), were heated and dissolved. The dissolved components were then charged into 250 parts of an 8% polyvinylalcohol aqueous solution together with a mixed solution of 20 parts of aromatic polyvalent isocyanate prepolymer and 40 parts of ethyl acetate (encapsulating agent). After emulsifying and dispersing these components, the mixture was stirred at 90° C. for about 1 hour, and 2 parts of water-soluble aliphatic modified amine was added as a reactant. The mixture was further stirred for about 3 hours at the maintained liquid temperature of 90° C. to obtain a dispersion liquid of colorless capsule particles. The capsule particle dispersion liquid was then placed in a freezer at below −5° C. to cause color formation and then restored to room temperature, whereby a dispersion liquid containing blue-colored particles C1 at a solid content of about 25%, was obtained. The colored particles C1 had a volume-average particle diameter of 2 μm, as measured by a laser method with a particle size distribution measurement device (Shimadzu Corporation; SALD7000; measurable particle diameter range of 10 nm to 300 μm). The full decoloration temperature Th was 85° C., and the full coloration temperature Tc was −5° C.

### Example 1

To 25 parts of the above-prepared dispersion liquid of resin-pigment-release agent mixture fine particles, 75 parts of de-ionized water was added and mixed, under stirring by paddle blades rotating at 800 rpm (common to dispersion, aggregating and fusion steps in all Examples and Comparative Examples). Then, as an aggregating agent, 5 parts of 0.5% hydrochloric acid was added thereto at 30° C. to aggregate the fine particles. Thereafter, 5 parts of an aqueous solution of 10% sodium hydroxide was added thereto to adjust the pH to 7.3, and the temperature of the resulting mixture was raised from room temperature to a fusion temperature of 90° C. at a rate of 10° C./min, and the mixture was held at 90° C. for 2 hours. Thereafter, the mixture was cooled to room temperature. After the cooling, the solid matter in the obtained dispersion liquid was collected by centrifugation. Thereafter, washing with de-ionized water and centrifugation were repeated until the electrical conductivity of the liquid after washing was lowered to 50 μS/cm. Then, the washed solid matter was dried using a vacuum dryer until the water content therein became 0.3%, whereby toner particles were obtained.

After the drying, as additives, 2 parts of hydrophobic silica having an average primary particle diameter of 30 nm and 0.5 part of titanium oxide having an average primary particle diameter of 20 nm were attached to the surfaces of 100 parts of the toner particles, whereby a desired electrophotographic toner was obtained.

The volume-average particle diameter of the thus obtained electrophotographic toner was measured at 5.25 μm using Multisizer 3 (aperture: 100 μm) manufactured by Beckman Coulter, Inc. The micro/semimacro roughness ratio (the ratio of {an average of an arithmetic average height (Ra) in a 0.5 μm-square region} to {an average of an arithmetic average height (Ra) in a 1 μm-square region} of a toner particle surface) was 0.66.

### Example 2

An electrophotographic toner was obtained in the same manner as in Example 1 except that the temperature of the dispersion liquid obtained by subjecting the dispersion liquid of resin-pigment-release agent mixture fine particles to aggregation and pH adjustment was raised to a fusion temperature of 80° C., and immediately thereafter the dispersion liquid was cooled.

The thus obtained electrophotographic toner exhibited a volume-average particle diameter of 5.41 μm and a micro/semimacro roughness ratio of 0.52.

### Example 3

An electrophotographic toner was obtained in the same manner as in Example 1 except that the temperature of the dispersion liquid of resin-pigment-release agent mixture fine particles to aggregation and pH adjustment was raised to a fusion temperature of 90° C., and immediately thereafter the dispersion liquid was cooled.

The thus obtained electrophotographic toner exhibited a volume-average particle diameter of 5.34 μm and a micro/semimacro roughness ratio of 0.60.

### Example 4

An electrophotographic toner was obtained in the same manner as in Example 1 except that the temperature of the dispersion liquid obtained by subjecting dispersion liquid of resin-pigment-release agent mixture fine particles to aggregation and pH adjustment was raised to a fusion temperature of 90° C., and the dispersion liquid was held at 90° C. for 5 hours and thereafter cooled.

The thus obtained electrophotographic toner exhibited a volume-average particle diameter of 5.17 μm and a micro/semimacro roughness ratio of 0.76.

### Example 5

An electrophotographic toner was obtained in the same manner as in Example 1 except that the temperature of the dispersion liquid obtained by subjecting the dispersion liquid obtained by subjecting the dispersion liquid of resin-pigment-release agent mixture fine particles to aggregation and pH adjustment was raised to a fusion temperature of 75° C., and the dispersion liquid was held at 75° C. for 5 hours and thereafter cooled.

The thus obtained electrophotographic toner exhibited a volume-average particle diameter of 5.49 μm and a micro/semimacro roughness ratio of 0.54.

### Example 6

15 parts of the above-prepared dispersion liquid of resin-pigment-release agent mixture fine particles, 1.7 parts of the above-prepared dispersion liquid of coloring agent and 68.5 parts of de-ionized water were mixed, and parts of 5%-aluminum sulfate aqueous solution as an aggregating agent was added thereto at 30° C. The mixture liquid was then raised to 40° C. and held at the temperature for 1 hour, followed by addition thereto of 10 parts of 10%-sodium polycarboxylate aqueous solution. The resultant mixture liquid dispersion was then raised to 80° C. and held at that temperature for 2 hours.

Thereafter, the dispersion liquid was subjected to cooling, recovery and drying of the solid matter and surface attachment of the hydrophobic silica and titanium oxide in the same manner as in Example 1 to obtain an electrophotographic toner.

The thus obtained electrophotographic toner exhibited a volume-average particle diameter of 5.64 μm and a micro/semimacro roughness ratio of 0.62.

### Comparative Example 1

An electrophotographic toner was obtained in the same manner as in Example 1 except that the temperature of the dispersion liquid obtained by subjecting the dispersion liquid of resin-pigment-release agent mixture fine particles to aggregation and pH adjustment was raised to a fusion temperature of 75° C., and immediately thereafter, the dispersion liquid was cooled.

The thus obtained electrophotographic toner exhibited a volume-average particle diameter of 5.37 μm and a micro/semimacro roughness ratio of 0.47.

The electrophotographic toners obtained in the above Examples and Comparative Example were evaluated with respect to the following properties.

### [Evaluation Method]

### <Environmental Variation in Charge Amount>

A sample toner was left standing in a high-temperature and high-humidity environment (HH: 30° C./80% RH) or a low-temperature and low-humidity environment (LL: 10° C./20% RH) for one day, and thereafter, a triboelectric charge (unit: μC/g) thereof was measured using a powder charge amount measuring instrument (TYPE TB-203, manufactured by KYOCERA Chemical Corporation). The case where the charge ratio (HH/LL) after leaving the toner in both environments was 60% or more was rated as “A”, the case where the ratio (HH/LL) was 50% or more but less then 60% was rated as “B”, and the case where the ratio (HH/LL) was less than 50% was rated as “C”.

More specifically, the charge amount of a sample toner was measured by mixing the toner with a carrier to provide a toner concentration of, e.g., 8 wt % and stirring the mixture for 30 minutes by a Turbla shaker to charge the developer. The developer was subjected to the measurement by the above-mentioned powder charge amount measuring instrument.

### —Measurement Conditions—

0.05 g (denoted as M) of the developer was placed in a metal-made measurement vessel equipped with a 500-mesh screen and subjected to suction for 10 seconds to remove the toner. The measurement was repeated two times to record the measured voltages as q1 and q2. A toner charge amount Q was determined according to the following formula by using a measured voltage q and a toner weight calculated from the toner concentration:

Q/M=CV/m(μC/g),

wherein C: capacitance, V: measured voltage, m: toner weight calculated from a formula of m=M×ρ/100,

wherein M: weighed developer amount=0.05 (g), ρ=toner concentration (wt %).

Q/M=q/m=(q1+q2)/ρ.

### <Scattering and Image Quality>

Using a copier e-STUDIO 4520C manufactured by Toshiba Tec Corporation, which had been modified for evaluation of toner performances, printing was performed at a coverage of 8% on 15,000 sheets of plain paper in a normal-temperature and normal-humidity (25° C./55%) environment, and for the resulting printed image, the scattering amount and image quality were evaluated.

The scattering amount of toner within the copier machine was evaluated by visual observation after printing was performed on 15,000 sheets of paper and rated at three grades of “A”, “B”, and “C” in the order of from “small” to “large” in scattered amount.

Further, the image quality was evaluated by visual observation with respect to a print obtained at a point after printing on about 100 sheets of paper. The case where the image quality was evaluated to be highest on a relative basis was rated as “A”, and the case where the image quality was evaluated to be lowest on a relative basis was rated as “C”, and the case where the image quality was evaluated to be an intermediate level was rated as “B”.

The evaluation results are summarized in the following Table 1 along with the summary of the properties of the respective toners.

TABLE 1

| | Particle size | | | Fusion | | | | | | | Evaluation results | | |
|---|---|---|---|---|---|---|---|---|---|---|---|---|---|
| | distribution | | BET | conditions | Ra | | | Triboelectric | | | Environ- | | |
| | Dv | | value | (Temp./ | 0.5 μm- | 1.0 μm- | Ra(0.5 μm)/ | chrage (μC/g) | | | mental | Scat- | Image |
| Example | (μm) | CV | (m²/g) | Time) | square | square | Ra (1.0 μm) | LL | HH | HH/LL | change | tering | quality |
| 1 | 5.25 | 20.1% | 3.6 | 90° C./2 H | 0.079 | 0.119 | 0.66 | −44.82 | −30.17 | 67.3% | A | A | A |
| 2 | 5.41 | 22.8% | 5.8 | 80° C./0 H | 0.181 | 0.348 | 0.52 | −49.65 | −28.71 | 57.8% | B | B | B |
| 3 | 5.34 | 21.5% | 4.2 | 90° C./0 H | 0.092 | 0.153 | 0.60 | −46.54 | −29.14 | 62.6% | B | A | A |
| 4 | 5.17 | 22.6% | 2.8 | 90° C./5 H | 0.072 | 0.095 | 0.76 | −43.58 | −31.85 | 73.1% | A | A | A |
| 5 | 5.49 | 21.4% | 5.4 | 75° C./5 H | 0.212 | 0.391 | 0.54 | −48.21 | −27.64 | 57.3% | B | B | B |
| 6 | 5.64 | 20.3% | 3.9 | 85° C./2 H | 0.114 | 0.183 | 0.62 | −45.87 | −30.18 | 65.8% | A | A | A |
| Comp. 1 | 5.37 | 20.6% | 6.7 | 75° C./0 H | 0.253 | 0.534 | 0.47 | −57.84 | −20.41 | 35.3% | C | C | C |

From the results shown in the above Table 1, it can be understood that the toners of Examples 1 to 6 in which the micro/semimacro roughness ratio (=Ra (0.5 μm)/Ra (1.0 μm)) was adjusted to 0.5 or more by controlling the fusion condition after aggregation exhibited significantly improved properties in all respects of environmental variation, scattering, and image quality.

What is claimed is:

1. An electrophotographic toner, comprising at least a binder resin and a coloring agent, wherein a toner surface has a ratio of {an average of an arithmetic average height (Ra) in a 0.5 μm-square region} to {an average of an arithmetic average height (Ra) in a 1 μm-square region} of 0.5 or more.

2. The toner according to claim 1, wherein the toner has a volume-average particle diameter of from 3 to 8 μm and has a CV value of 28% or less.

3. The toner according to claim 1, wherein the toner has a BET specific surface area of from 1.5 to 6.0 m²/g.

4. The toner according to claim 1, wherein the toner has been produced by a wet process including aggregation and fusion.

5. The toner according claim 1, wherein the toner contains, as external additives, at least hydrophobic silica having an average primary particle diameter of 80 nm or less and titanium oxide having an average primary particle diameter of 50 nm or less.

6. The toner according claim 1, wherein a toner particle surface in a state where an external additive is attached thereto, has a ratio of {an average of an arithmetic average height (Ra) in a 0.5 μm-square region} to {an average of an arithmetic average height (Ra) in a 1 μm-square region} of 0.5 or more.

7. The toner according claim 1, wherein the coloring agent contains a color-forming compound and a color-developing agent, whereby the toner is erasable.

8. The toner according claim 1, further comprising a release agent.
